(19) United States
(12) Patent Application Publication
(10) Pub. No.: US 2017/0230474 A1
(43) Pub. Date: Aug. 10, 2017

(54) SERVICE COMPONENT MANAGEMENT METHODS AND SYSTEMS

(71) Applicant: Alibaba Group Holding Limited, George Town (KY)

(72) Inventors: Jinglu HAN, Hangzhou (CN); Chunhui ZHANG, Hangzhou (CN); Yanming CAI, Hangzhou (CN); Yongsheng ZHU, Shanghai (CN); Ping DONG, Hangzhou (CN); Bo QIANG, Hangzhou (CN); Yitong QI, Hangzhou (CN); Zhiping LIN, Shanghai (CN); Ke CHENG, Shanghai (CN)

(21) Appl. No.: 15/415,099

(22) Filed: Jan. 25, 2017

(30) Foreign Application Priority Data
Jan. 28, 2016 (CN) 201610059899.3

(51) Int. Cl. H04L 29/08

(52) U.S. Cl. CPC H04L 67/2838; H04L 67/16; H04L 67/1095; G06Q 50/14

(57) ABSTRACT

A second service component-oriented information entity sent by a first service component is sent to a second service component that processes the information entity, so that interaction between the service components based on the information entity is realized, and the association between the service components is also realized. A service component in an operating system can execute a specific function or provide a specific service. The function or service can be provided by the system or an application program. The information entity can transmitted among multiple service components to perform a function or service.

### RELATED APPLICATION

This application claims priority to Chinese Patent Application No. 201610059899.3, filed on Jan. 28, 2016, with the State Intellectual Property Office of the People's Republic of China, incorporated by reference in its entirety herein.

### FIELD

Embodiments according to the present invention relate to the field of communication technology, and particularly relate to service component management methods and systems.

### BACKGROUND

With the rapid development of mobile communication technology and the arrival of the mobile multimedia era, the mobile phone has become an essential mobile communication tool and has evolved from a simple tool for making phone calls into a mobile personal information acquisition and processing platform. Smart phones have become mobile terminals by virtue of their rich operating systems and application software.

At present, mainstream smart phone operating systems include Google's Android™, Apple's iOS, and the like. In the Android™ operating system, an “Activity” is a single, focused thing that a user can do. A specific service scenario is realized by an application that uses Activity as a unit, and such an application only supports limited access to the Activities of other applications. In both Android™ and iOS, if a user wants to accomplish a particular service, the user must move (“jump”) multiple times from one application to another, but the movement of data between the applications is limited. For example, when a user is making vacation travel arrangements, the user needs to research where to go, book flights and hotels, make payments, check weather information, and so on. To accomplish this in the Android™ or iOS operating system environment, the user needs to use a browser for research, book flights and hotels with a travel service application program, make payments with a payment application program, and check weather with a weather application program. Thus, multiple jumps among multiple application programs are required. However, data cannot be transmitted between the application programs, inconveniencing the user.

A flexible and convenient solution to this problem would be valuable.

### SUMMARY

Embodiments according to the present invention provide service component management methods and systems that address the problem presented above.

In an embodiment, a service component management method includes receiving a second service component-oriented information entity sent by a first service component and sending the information entity to the second service component. Before sending the information entity to the second service component, an instance of the second service component can be created by, for example, acquiring executable program code corresponding to the second service component, executing the executable program code, and allocating an execution environment to the executable program code. The second service component may be a local service component or a remote service component.

In an embodiment, after sending the information entity to the second service component, a result of processing the information entity returned by the second service component is received, and the result returned by the second service component is sent to the first service component.

In an embodiment, the operation of sending the information entity to the second service component includes determining whether the second service component is a local service component or a remote service component, and sending the information entity to a server corresponding to the second service component if the second service component is a remote service component. If the information entity is sent to the server corresponding to the second service component, then afterwards a result of processing the information entity sent by the server can be received and the processing result sent by the server can be sent to the first service component.

The information entity can include at least a URI (Uniform Resource Identifier) of a target service component, where the URI of the target service component corresponds to one or more second service components. The URI of the target service component can carry parameters. The parameters can be determined according to the event received by the first service component. The event can include, for example, an event generated when a control on a user interface (UI) corresponding to the first service component is triggered, a set system event; or a set non-system event. The parameters can be used for indicating set entries of the second service component. The information entity can further include one or any combination of the following contents: data and events.

Embodiments according to the present invention also provide a service component management device that includes a first receiving unit that is used for receiving a second service component-oriented information entity sent by a first service component, and a first sending unit that is used for sending the information entity to the second service component. The device can also include a creating unit that is used for creating an instance of the second service component before the information entity is sent to the second service component. In an embodiment, the creating unit is used for acquiring executable program code corresponding to the second service component, running the executable program code, and allocating an execution environment to the executable program code.

In an embodiment, the device also includes a second receiving unit that receives a result of processing the information entity returned by the second service component after the information entity is sent to the second service component, and a second sending unit that sends the processing result returned by the second service component to the first service component.

In an embodiment, the first sending unit determines at least one second service component registered to listen to the event according to the information included in the URI of the target service component in the information entity and used for characterizing a broadcast event, and sends the information entity to the second service component registered to listen to the event. The first sending unit can also determine whether the second service component is a local service component or a remote service component and can send the information entity to a server corresponding to the second service component if the second service component is a remote service component.

Embodiments according to the present invention also perform a service component interaction method that includes generating, with a first service component, a second service component-oriented information entity according to received information that includes an event and/or data, and sending, with the first service component, the information entity to the second service component. The event can include an event generated when a control on a UI corresponding to the first service component is triggered, a set system event, or a set non-system event. The operation of generating the second service component-oriented information entity can include determining a target service component configured with the event according to the received event and writing the URI of the target service component to a corresponding field of the information entity. The operation of generating the second service component-oriented information entity can also include writing the received event and/or data to a corresponding field of the information entity.

In embodiments, the service component interaction method also includes receiving a result of processing the information entity returned by the second service component, and/or receiving a first service component-oriented information entity sent by a third service component and processing the information entity received by the second receiving unit. The operation of processing the information entity received by the second receiving unit can include executing an operation corresponding to the event included in the information entity according to the data included in the information entity if the received information entity includes data and an event.

In embodiments, the information entity is processed with the second service component. If the information entity includes data and an event, then the processing can include executing an operation corresponding to the event included in the information entity according to the data included in the information entity.

Embodiments according to the present invention also provide a service component (e.g., the aforementioned first service component) that includes a generation unit that generates a second service component-oriented information entity according to received information that includes an event and/or data, and a sending unit that sends the information entity to the second service component. In an embodiment, the generation unit generates the information entity according to the received information and writes the received event and/or data to a corresponding field of the information entity. In an embodiment, the first service component also includes a first receiving unit that receives from the second service component a result of processing the information entity. The first service component can also include a second receiving unit that receives a first service component-oriented information entity sent by a third service component, and a processing unit that processes the information entity received by the second receiving unit. If the information entity received by the receiving unit includes data and an event, then the processing unit can execute an operation corresponding to the event included in the information entity according to the data included in the information entity.

Embodiments according to the present invention also include a terminal device that includes memory, used for storing computer program instructions, and a processor, used for reading the computer program instructions stored in the memory and executing operations that include receiving a second service component-oriented information entity sent by a first service component and sending the information entity to the second service component.

When the information entity includes at least a URI of a target service component and an event, then the URI of the target service component can include information for characterizing a broadcast event, and the operation of sending the information entity to the second service component includes: determining at least one service component registered to listen to the event according to the information included in the URI of the target service component in the information entity and used for characterizing the broadcast event, and sending the information entity to the second service component registered to listen to the event.

The information entity can also include indication information, which is used for determining the ongoing processing operation by the second service component. The indication information can include first indication information that is used for indicating whether the first service component and the second service component are in the same service component group. A service component group can include at least two service components, and can be set according to a service scenario.

The indication information can also include second indication information that is used for indicating whether the target service component needs to enter a specified state or indicating an interactive mode between the target service component and a user interface. The specified state can include at least one of the following states: a hidden state, in which the service component runs in the background and is invisible to a user; a shown-inactive state, in which the service component is visible to a user but does not respond to a user input; and a shown-active state, in which the service component is visible to a user and responds to a user input. The interactive mode can include at least one of the following modes: a shown-active mode; and a shown-inactive mode.

The information entity can further include a URI of the first service component and/or a component identifier (ID) of the second service component, where the component ID is used for indicating an instance corresponding to the ID among multiple instances when the second service component has multiple instances.

In embodiments according to this disclosure, after a second service component-oriented information entity sent by a first service component is received, the information entity is sent to the second service component, so that interaction between the service components based on the information entity is realized and then association between the service components is realized. A service component can execute a specific function or provide a specific service. The function or the service can be provided by the system or an application program. The information entity can be transmitted among multiple service components to perform a service.

These and other objects and advantages of the various embodiments according to the present invention will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the detailed description, serve to explain the principles of the disclosure.

FIG. 1 is a diagram of a mutual relation between “Pages” according to an embodiment of the present invention.

FIG. 2 is a diagram of an example of Page state conversion according to an embodiment of the present invention.

FIG. 3 is a diagram of an example of Page state conversion according to an embodiment of the present invention.

FIG. 4 is a diagram of a service component management system according to an embodiment of the present invention.

FIG. 5 is a diagram of service component management flow according to an embodiment of the present invention.

FIG. 6 is a diagram of service component management flow according to an embodiment of the present invention.

FIG. 7 is a diagram of a relationship among Pages according to an embodiment of the present invention.

FIG. 8 is a diagram of a service component management device according to an embodiment of the present invention.

FIG. 9 is a diagram of a service component according to an embodiment of the present invention.

FIG. 10 is a diagram of a terminal device according to an embodiment of the present invention.

### DETAILED DESCRIPTION OF THE EMBODIMENTS

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “providing,” “sending,” “creating,” “acquiring,” “executing,” “allocating,” “determining,” “processing,” “creating,” “running,” “generating,” “writing,” or the like, refer to actions and processes of an apparatus or computer system or similar electronic computing device or processor. A computer system or similar electronic computing device manipulates and transforms data represented as physical (electronic) quantities within memories, registers or other such information storage, transmission or display devices.

Embodiments described herein may be discussed in the general context of computer-executable instructions residing on some form of computer-readable storage medium or media, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

Embodiments according to the present application will be described in detail below in combination with the accompanying drawings.

A service-oriented architecture is a style of software design where services are provided to the other components by application components, through a communication protocol over a network. A service is a discrete unit of functionality that can be accessed remotely and acted upon and updated independently. Embodiments according to the present invention provide a service component management solution for facilitating and improving interaction and association between different service components. Embodiments according to the present application can be applied to various operating systems (OSs), e.g., cloud OSs, such as YunOS. The following embodiments are described using YunOS as an example. While a YunOS-based service component management solution is described, embodiments according to the invention are not so limited.

Described first are terms that are related to embodiments of the present invention using YunOS.

### Page

As used herein, a Page is a service component, an abstraction of local services and remote services—that is, a basic unit of services—and can provide various services (e.g., online services or web-based services) by packaging data and methods. A service scenario may include multiple Pages. For example, a Page may be a service such as generating a UI (user interface), photographing, or the like, or a Page may be a background service, e.g., account authentication. The executing Page is referred to as a Page instance and is a carrier of local services or remote services, and can be created, scheduled, and managed by Dynamic Page Management Service (DPMS). For example, after receiving a PageB-oriented Pagelink sent by a PageA, the DPMS can create an instance of PageB and the DPMS can maintain the life cycle of the Page instance (a Pagelink is discussed further below).

Each Page can be uniquely identified. For example, a Page can be identified with a URI (Uniform Resource Identifier). The URI can be generated in various ways and, as long as uniqueness can be ensured, the present invention does not limit how the URI is generated.

In an embodiment, the URI for identifying a Page includes the following information domains: a resource type domain, used for carrying resource type indication information; a domain name domain, used for carrying indication information of a resource domain; and a path domain, used for carrying a path of a resource, e.g., a path of a resource in its domain.

A resource can have three types, which are respectively referred to as a first type, a second type and a third type. The first type is used for expressing that the resource is stored in an external memory. The second type is used for expressing that the resource is not stored in external memory; instead, it is stored locally in, for example, a subscriber identity module (SIM) card, and the source is a resource of an application program itself (e.g., a resource after an application program installation packet is decompressed). The third type is used for expressing that the resource is not stored in external memory; instead, it is stored locally in, for example, a SIM card, and the source is a resource when an application program executes (e.g., a resource generated when the application program executes).

The resource types may further include a fourth type that is used for expressing that the resource is stored on the network side (e.g., in a cloud).

The above resource types are only examples, and the embodiments according to the present application can include other resource types.

Based on the above classification, the resource type domain includes a first field and a second field. If the value of the first field indicates that the type of resource is the first type, then the second field is empty; otherwise, the value of the second field indicates that the type of the resource is the second type or the third type.

The URI for identifying a Page can include one or more of the following information domains: a user information domain, used for carrying user information, where the user may be a resource request user; and/or a parameter domain, used for carrying parameters.

An example format of a resource URI is: scheme://username/domain/subscheme/path?param1=xxx&param2=xxx.

The “scheme” domain is a resource-type domain, used for carrying resource-type indication information. This information domain is a required item. The value of the information domain is “page” or “file.” If the value of the scheme domain is “file,” then the resource is the first type; if the value of the scheme domain is “page,” then the type of the resource needs to be further determined according to the value of the subscheme domain. The value of the scheme domain may also be “http” or “https,” indicating that the accessed resource is a cloud resource.

The “subscheme” domain is an extended resource-type domain, used for carrying extended indication information about the resource type. This information domain is an optional item. When the value of the scheme domain is “file,” the URI does not include the subscheme domain or the value of the subscheme domain is Null; and when the value of the scheme domain is “page,” the URI includes the subscheme domain. The value of the subscheme domain may be “asset” or “data;” if the value of the subscheme domain is “asset,” then the resource is a resource of an application program itself; and if the value of the subscheme domain is “data,” then the resource is a resource when an application program executes.

The “username” domain is used for carrying information (e.g., a user name) about the user that is initiating a resource access request.

The “domain” domain is used for carrying indication information (e.g., a domain name) about a domain of the resource.

The “path” domain is used for carrying a path for the resource in its domain, that is, a relative path. The path may also include “asset” or “data,” which represents the structure of the relative path (e.g., it is a primary directory).

The “param” domain is used for carrying parameters that are being transmitted.

The URI can serve as an address link, and the corresponding Page can be uniquely determined via the URI. For example, in order to distinguish the service provided by a Page, the URI allocated to the Page can selectively include relevant information about or for the service, such as but not limited to a service name, a service content, or a service provider. For example, the URI allocated to the Page corresponding to a calendar service provided by company A can be as follows: Page://calendar.a.com; where “Page://” is used to distinguish the address corresponding to the Page from the addresses of other types; “calendar” refers to the provided service name; and “a” identifies the provider (company A) of the service.

Depending on the scenario, multiple Page instances may be created for one Page, and a unique Page ID can be further allocated to each Page instance in order to distinguish different instances of the same Page. The Page ID can be allocated when the Page instance is created. The Page instance indicates the running state of the Page; that is, an executing carrier of local or remote services (e.g., DPMS) creates and schedules the Page instance and manages its life cycle. The Page ID can be carried in an information entity PageLink and transmitted.

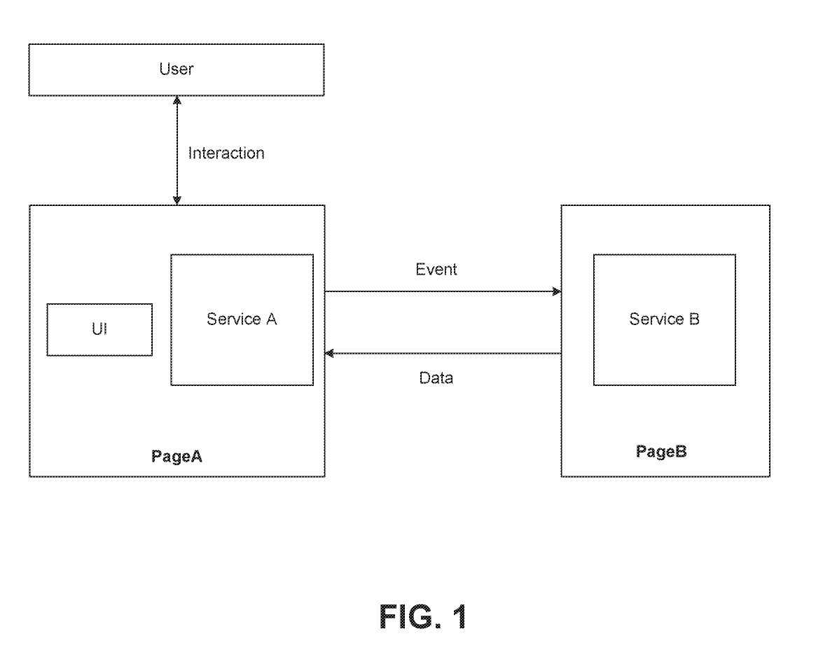

Events and/or data can be transmitted between Pages, and a Page can interact with a user via the UI to provide a service. As shown in FIG. 1, PageA can send an event to PageB and receive data from PageB in return, and PageA can interact with a user via the UI. PageA can provide service A, and PageB can provide service B. PageA can also provide a display interface for the user in a UI mode, as well as display a service and receive various inputs from the user via the interface, and PageB can mainly execute in the background and provide service support for other Pages.

A Page can be created and destroyed. A Page has three states: a Created state; a Running state; and a Stopped state. A Page is created, and the created (instantiated) Page first enters the Created state. The activated Page enters the Running state, in which events and/or data can be transmitted between Pages, and in which events and/or data transmitted by other Pages in the Running state can be processed. A deactivated Page enters a Stopped state, in which the Page cannot transmit events and/or data with other Pages.

A Page can be converted from one state to another, and receives a life event notification during its conversion. The life event notification indicates the state of the converted Page. The state conversion of the Page and the life event notification can be controlled by the DPMS.

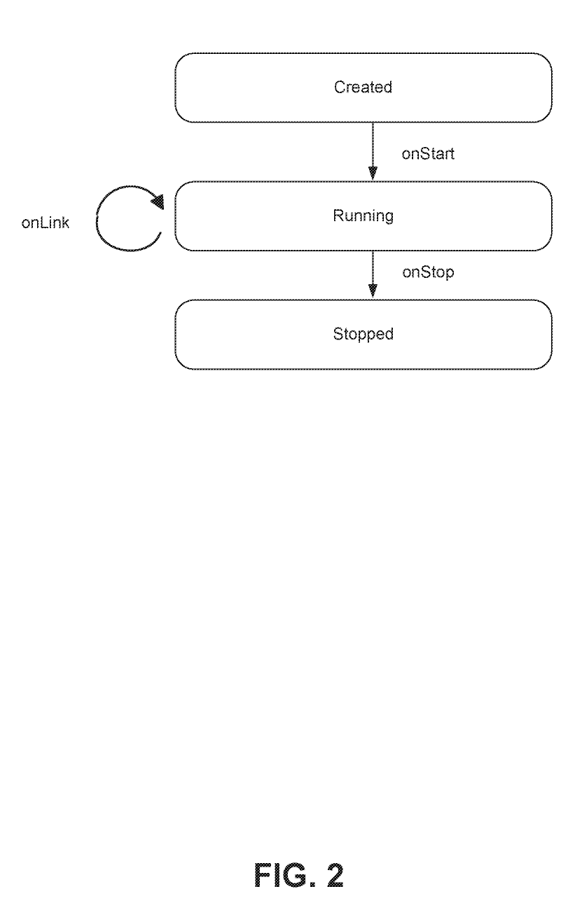

FIG. 2 shows a diagram of an example of Page state conversion. As shown in FIG. 2, when the Page enters the Running state from the Created state, it receives an onStart event. When the Page enters the Stopped state from the Running state, it receives an onStop event. In the Running state, the Page can receive a Pagelink sent by other Page via an onLink interface. The onStart event is used as a life event notification that indicates the Page is starting to enter the Running state, and the onStop event is used as a life event notification that indicates that the Page is starting to enter the Stopped state.

If the Page has a UI, then the Running state can be extended into one of the following three states: a Hidden state; a Shown-inactive state; and a Shown-active state. In the Hidden state, the Page can run in the background and is invisible to a user. In the Shown-inactive state, the Page is visible to a user but does not respond to a user input. In the Shown-active state, the Page is visible to a user and can respond to a user input.

For example, if PageA is a full-screen window and PageB is a non-full-screen window, then when PageB is displayed on PageA, PageA is in the Shown-inactive state and PageB is in the Shown-active state.

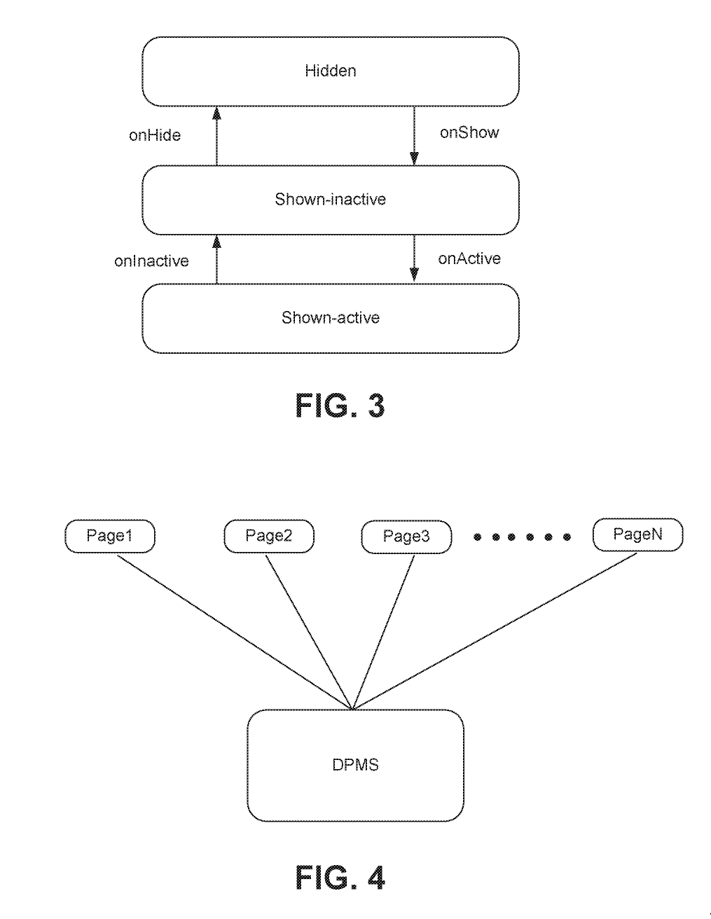

A Page can be converted between the above different states via the life event notification. FIG. 3 shows a diagram of an example of Page state conversion. As shown in FIG. 3, the Page in the Hidden state enters the Shown-inactive state after receiving an onShow event, and the Page in the Shown-inactive state enters the Hidden state after receiving an onHide event. Also, the Page in the Shown-inactive state enters the Shown-active state after receiving an onActive event, and the Page in the Shown-active state enters the Shown-inactive state after receiving an onInactive event.

### PageLink

As used herein, a PageLink is an information entity circulated between Pages. Information (e.g., events and/or data and the like) can be transmitted between Pages. A set API (Application Programming Interface) can be used for specific data transmission and, based on this, an association between the service components is recorded (e.g., by YunOS). A PageLink can designate the URI of a target Page, and can include one or more of events, data, services, and the like.

Pages are combined more flexibly via a PageLink, to realize rich service scenarios.

### DPMS

DPMS can be regarded as a service component management entity and is a system service. DPMS can manage the life cycle and execution scheduling of a Page and the life cycle of the Page from creation to destruction, and interactions between Pages via a PageLink are realized by DPMS.

Embodiments according to the present invention provide a service component management system, which may include a service component management entity and N (N is an integer more than 1) service components. Based on the architecture, the service component management entity can receive an information entity sent by one service component (referred to herein as a first service component) and oriented to another service component (referred to herein as an information entity of a second service component), and send the information entity to the second service component for processing.

Using YunOS as an example, the service component management system can be considered to be a part of YunOS. As shown in FIG. 4, the service component management system can include a DPMS and N Pages. The DPMS can be a resource scheduling manger module in the operating system, and various Pages can constitute a service resource pool. Correspondingly, the DPMS can receive a PageLink sent by one Page (referred to herein as a first Page) and oriented to another Page (referred to herein as a second Page), and can send the PageLink to the second Page for processing, thereby realizing interaction, association, and jumping between different Pages.

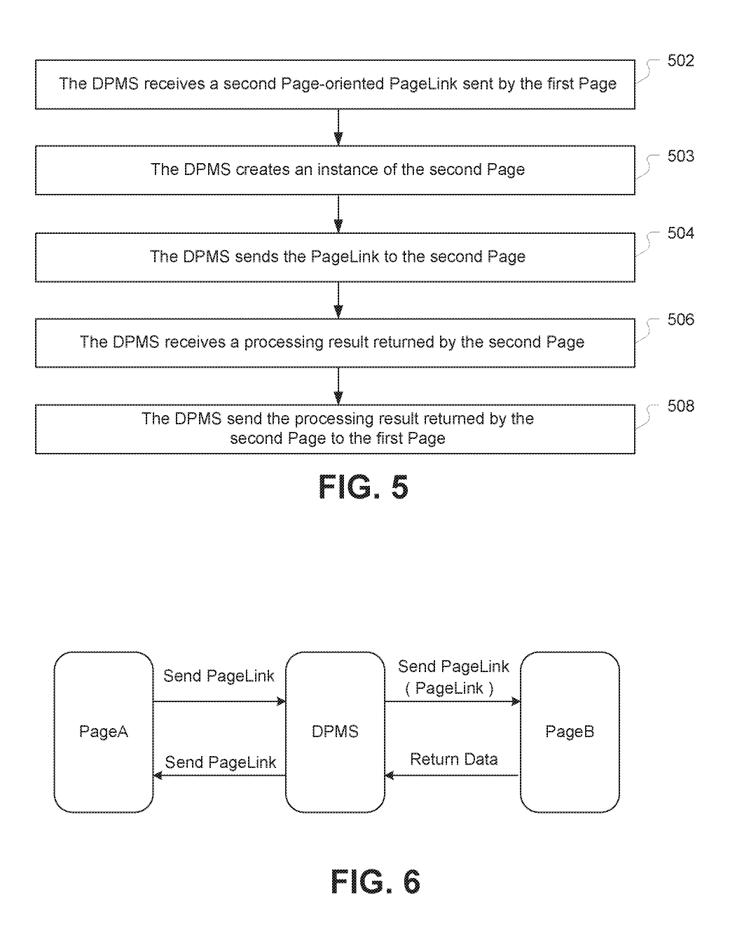

An embodiment of a service component management process will be described in detail below in combination with FIG. 5 using YunOS as an example. As shown in FIG. 5, the service component management process can include the following steps.

Before step 502 is performed, the first Page can generate a Pagelink according to received information, where the received information can include an event and/or data. Specifically, one or more of the following situations or events can cause the first Page to generate the PageLink:
receiving a PageLink sent by another Page;
processing the PageLink sent by the other Page, and sending a PageLink to the second Page according to the service processing logic of the first Pagelink;
receiving a processing result returned by the other Page, and then sending a PageLink to the second Page according to the service processing logic of the first Pagelink;
a user carries out an interface operation on the user interface corresponding to the first Page, and the interface operation triggers the first Page to generate the second Page-oriented PageLink;
a set event (including a system event or a self-defined event) occurs and causes the first Page to generate the second Page-oriented PageLink; and
the first Page generates the second Page-oriented PageLink based on a set time point or cycle.

In step 502, the first Page sends a second Page-oriented information entity (referred to as PageLink) to the DPMS, and the DPMS receives the second Page-oriented PageLink sent by the first Page. The first Page can be a local Page or a remote Page. Similarly, the second Page can be a local Page or a remote Page. Generally, the first Page, serving as a PageLink sender in the Running state, sends the second Page-oriented PageLink.

When the first Page generates the second Page-oriented PageLink according to a received event, the event can include one of the following events: an event generated when a control on a user interface corresponding to the Page is triggered; a set system event; or a set non-system event, which can be a self-defined event. More specifically, when the first Page generates the PageLink, a target Page configured with the event can be determined according to the received event, and the URI of the target Page is written into a corresponding field of the target Page-oriented PageLink. Even more specifically, when the first Page generates the PageLink, the received event and/or data can be written into a corresponding field of the PageLink.

In step 504, the DPMS sends the PageLink to the second Page. The DPMS can first determine whether the second Page is a local Page or a remote Page, and if the second Page is a remote Page, then the DPMS sends the Pagelink to a server corresponding to the second Page. Generally, when each Page is issued, a list is generated that identifies which Pages are local and which Pages are remote (e.g., in the cloud). If the Page is local, a code corresponding to the Page is stored locally, and if the Page is in the cloud, then the PageLink is sent to the cloud (according to the URL provided by the cloud) and the cloud returns the processing result.

In an embodiment, in step 506, the second Page processes the received PageLink, and returns a processing result to the DPMS.

In an embodiment, in step 508, the DPMS receives the processing result returned by the second Page, and sends the processing result returned by the second Page to the first Page.

With regard to step 506 and step 508 above, if the DPMS sends the PageLink to the server corresponding to the second Page in step 504, then that server returns the processing result on the PageLink to the DPMS in step 506, and the DPMS sends the processing result sent by the server to the first Page in step 508.

After receiving the second Page-oriented PageLink sent by the first Page, the DPMS can first create an instance of the second Page. That is, in an embodiment, step 503 is performed before step 504. In step 503, the DPMS creates an instance of the second Page, wherein the instance is used for processing the PageLink sent by the first Page. The Page has different states as described above. In an embodiment, the state of the second Page is set to the Running state while the instance of the second Page is created and the Page in the Running state processes the received PageLink.

The process in which the DPMS creates the instance of the second Page can include acquiring executable program code corresponding to the second Page, executing the executable program code, and allocating an execution environment to the executable program code. A process corresponding to the second Page can be created first, an execution environment for the process is set up (e.g., the position of the executable program code of the second Page itself and the position of a resource can be set), memory is allocated, and then the executable program code and the entry of the resource are loaded and the process starts to execute. In a specific implementation, the Page instance is created with reference to a standard flow of object instantiation.

As an example, PageA sends a PageLink to PageB via the DPMS, as shown in FIG. 6. PageA generates a PageB-oriented PageLink and sends the PageLink to the DPMS, the DPMS triggers PageB to enter a Running state (e.g., it activates PageB) and sends the PageLink to PageB, PageB processes the received PageLink and sends the processing result to the DPMS, and the DPMS returns the processing result to PageA.

The second Page-oriented PageLink sent by the first Page in the above example at least includes a URI of a target Page, and can also include a URI of the first Page. In an alternative implementation, the PageLink sent by the first Page does not include the URI of the first Page, and the DPMS adds identification information such as the URI of the first Page and the like to the PageLink after receiving the PageLink. The DPMS or the core frame layer of the YunOS system can record the relationship between the Pages. For example, the DPMS records the URI of the sender Page of the PageLink and the URI of the receiver Page.

The URI of the target Page corresponds to one or more second Pages. In an implementation, the URI of the Page can be divided into two types: a definite URI and a general URI. A definite URI corresponds to one Page, while a general URI corresponds to multiple Pages. Some URIs can be reserved as general URIs, which can respond to multiple Pages other than one unique Page. The general URIs are reserved by the system, and the URIs of the Pages themselves may not be allowed to be the same as the general URIs.

As an example, when the URI of the target Page is a general URI, the DPMS processes the PageLink in such a mode. That is, after receiving the PageLink, the DPMS searches all Pages in the system, and all the Pages registered to listen to the Event carried by the PageLink receive the PageLink for processing.

In some embodiments, in the second Page-oriented PageLink sent by the first Page, the URI of the second Page carries some parameters so that the parameters are transmitted to the second Page. The parameters are used for indicating set entries of the second Page, such as a service entry, a function entry, an information entry, and the like of the second Page. The parameters are related to page load, and parameters that do not need to be encrypted and are related to page load can be carried in the URI.

As an example, the URI of a target Page in a PageLink sent to the setting page is: page://setting.example.com/setting?subpage=wifi, where subpage=wifi is a parameter carried in the URI, and the setting page may directly jump to a wifi-setting secondary page according to subpage=wifi. The parameters and the format of the URI can comply with the provisions of an HTML (HyperText Markup Language) protocol or other protocols, as long as the second Page can be identified. The URI carrying the parameters can be compatible with an HTML5 page.

In some embodiments, the parameters carried in the URI of the second Page are determined according to the event received by the first Page. That is, the first Page determines the parameters which need to be carried in the URI of the target Page according to the received event. For example, the event can include one or any combination of the following events: an event generated when a control on a UI corresponding to the first Page is triggered; a set system event; or a set non-system event.

The second Page-oriented PageLink can further include data. When the second Page processes the sent PageLink, the PageLink can be processed according to the transmitted data. One or more data instances can be transmitted to the second Page, and the data transmitted to the second Page can have multiple types; for example, the data types can include digits (integers or floating-point numbers), character strings, logic values (true or false), arrays, objects, and null.

Optionally, the data can be organized by adopting a JSON (JavaScript Object Notation) format. The JSON format is a lightweight data exchange format. JSON adopts a text format completely independent from a language, is suitable for data exchange, is easy to read and write, and is also easy to analyze with a machine and generate. The data format of JSON adopts a name/value combined pair form, the name in the name/value pair combination is written in front (in double quotation marks), the value pair is written in back (also in double quotation marks), the name is separated from the value pair by a colon, and different name/value pair combinations are separated by a comma, e.g., {“key1”:“value1”, “key2”:“value2”}. The data can also be organized by adopting other data structures, such as but not limited to XML (Extensible Markup Language).

The data transmitted from the first Page to the second Page via the PageLink can be carried in a data field or in an information unit in the PageLink, or carried in the URI of the target Page. The data transmitted via the data field or transmitted in the URI of the target Page can be pre-appointed by double communication parties (Pages).

The second Page-oriented PageLink can further include an event. The second Page can execute a corresponding operation according to the transmitted Event.

As an example, if the second Page-oriented PageLink includes data and an event, then the second Page processing the PageLink includes, according to the data included in the PageLink, executing an operation corresponding to the event included in the PageLink. For example, if the event transmitted to the second Page via the PageLink is an event in which a user clicks a “payment” button on a web page to execute payment, then the data transmitted to the second Page via the PageLink includes user account, payment amount, and recipient, and the following operations can be executed when the second Page processes the PageLink: logging into the payment page with the user account and performing on-line payment operation of the amount to the recipient when the user clicks the “payment” button on the web page.

An event is an operation that can be identified by a control input, e.g., pressing down an OK button or selecting an option button or a check box. Each control input can itself identify events (e.g., load events, a single click, double clicks, and the like of a window, or a text change event of an edit box (text box)). The events include system events and user events. The system events are initiated by the system, and the user events are initiated by users. An event drive control executes a certain function.

The second Page-oriented PageLink sent by the first Page can transmit one or more events, and the transmitted events can include system events and/or user events.

In some embodiments, two event types can be predefined: a broadcast event and a non-broadcast event. A broadcast event is an event registered to be broadcast, and a non-broadcast event is an event not registered to be broadcast. For example, a system-related event (e.g., a system shutdown event, corresponding to a series of operations of shutting down the system such as exiting a user interface) can be defined as a broadcast event. The occurrence of a broadcast event not only influences the target Page (e.g., the above-mentioned second Page) but also influences other Pages. Correspondingly, an event related to other specific service (e.g., an event related to an on-line payment operation) is defined as a non-broadcast event. A broadcast event can be defaulted so that it is listened to by all the Pages, or one or more Pages can be previously registered to listen to the broadcast event. Optionally, a broadcast event can be identified by the information included in the URI and used for characterizing the broadcast event.

After receiving the PageLink sent by the first Page, the DPMS identifies whether the event type included therein is a broadcast event or a non-broadcast event. If it is a broadcast event, then the DPMS can determine the Page registered to listen to the event and send the PageLink to the Page registered to listen to the event so that the Page carries out a corresponding operation. The DPMS can also send the PageLink to all the Pages registered to listen to the event, where all of or some of the Pages can be preconfigured to listen to the broadcast event. If the PageLink includes a non-broadcast event, then the DPMS can send the PageLink to the second Page, so that the second Page carries out a corresponding operation according to the non-broadcast event.

As an example of the broadcast event in a system shutdown scenario, the power management service sends a PageLink including “URI=broadcast.yunos.com, event=shutdown,” where “broadcast” indicates that the shutdown event is a broadcast event. The DPMS sends the PageLink to all the Pages registered to listen to the shutdown event.

As an example of the non-broadcast event in an account login scenario, the login page can send a point-to-point PageLink to the account service. The PageLink includes “URI=account.yunos.com, event=login, data={id=a, password=b}” but does not include information characterizing the login event is a broadcast event, and then the DPMS sends the PageLink to the target Page.

Based on the content included in the PageLink, in some embodiments, the second Page-oriented PageLink sent by the first Page can further include indication information, which is used for determining the processing operation to be performed by the target Page. The quantity and the type of the indication information are not limited.

For example, the indication information can include first indication information that indicates whether the first Page and the target Page (e.g., the second Page) are in the same Page group. Optionally, the first indication information can be Boolean data; for example, when the value of the first indication information is True, then the first Page (PageLink sender) and the second Page (PageLink receiver) are in the same Page group, and when the value of the first indication information is False, then the first Page and the second Page may not be in the same Page group.

A Page group can include one or more Pages. The Page group can be preconfigured or adjusted according to needs specified by the initiator (e.g., the first Page) in the PageLink. Pages in a Page group can be set according to service scenarios and are related to specific services or service scenarios. For example, for a travel service scenario, the Page for flight ticket query and the Page for payment of an on-line flight ticket can be configured in one Page group. For a daily ordering service scenario, the Page for the ordering query and the Page for on-line ordering payment can be configured in one Page group.

Taking the above travel scenario as an example, the first Page is the Page for flight ticket query and the second Page is the Page for payment of the flight ticket and, in the second Page-oriented PageLink sent by the first Page, if the value of the first indication information is True, then the first Page and the second Page are in the same Page group. In that case, after receiving the PageLink sent by the first Page, the DPMS can judge whether a second Page in the same Page group as the first Page exists and create an instance of the second Page if the second Page does not exist, where the instance of the second Page and the first Page belong to the same Page group. When the instance of the second Page is created, an instance suitable for the service scenario can be created according to the requirements of the travel scenario (e.g., allowing credit card payment but not using prepaid card payment).

Taking the above daily ordering scenario as an example, the first Page is the Page for ordering query and the second Page is the Page for on-line ordering payment and, in the second Page-oriented PageLink sent by the first Page, if the value of the first indication information is False, it expresses that the first Page and the second Page are not in the same Page group. In this case, after the DPMS receives the PageLink sent by the first Page, if the instance of the second Page is present and does not belong to any Page group, the PageLink can be sent to the second Page for processing.

Based on the division of the Page group, instances suitable for different service scenarios can be created for a general service component (e.g., a service component for payment) according to the requirements of the different service scenarios.

The indication information included in the PageLink can include second indication information that indicates whether the target Page is in a specific state (e.g., Hidden state, Shown-inactive state, Shown-active state). Optionally, the second indication information is Boolean data; when the value of the second indication information is True, it indicates that the second Page (PageLink receiver) needs to enter a specific state, and when the value of the second indication information is False, it indicates that the second Page does not need to enter the specific state. The second indication information can also be used to indicate an interactive mode (e.g., Shown-active mode or Shown-inactive mode) between the target Page and the UI. Like the above, the second indication information can optionally be Boolean data; when the value of the second indication information is True, it indicates that the second Page (PageLink receiver) needs to interact with the UI in a Shown-active mode, and when the value of the second indication information is False, it indicates that the second Page does not need to interact with the UI in the Shown-active mode (or needs to interact with the UI in a Shown-inactive mode).

As mentioned above, the Running state of a Page can be further subdivided into a Hidden state, a Shown-inactive state and a Shown-active state. In some embodiments, the second Page can determine whether to enter the Shown-active state according to the second indication information in the PageLink sent by the first Page.

Based on the above description of a PageLink, Table 1 shows an example of a data structure of a PageLink.

TABLE 1
Example Structure of a PageLink

| Field | Note | Examples |
|---|---|---|
| URI of | Definite Page | page://foobar.com/foobar |
| target | URI (carrying | page://foobar.com/foobar?param=value |
| Page | Param) | |
| | General Page | page://broadcast.foobar.com |
| | URI | page://service.foobar.com |
| Optional | Page start | inGroup=false, needActive=true |
| indication | parameter | |
| information | inGroup: target | |
| (options) | Page and sender | |
| | Page are in the | |
| | same group | |
| | needActive: | |
| | target Page | |
| | needs to be | |
| | activated | |
| Data | Data of JSON | {“key1”:“value1”, “key2”:“value2”} |
| | format | |
| Event | Sending the | “eventName” |
| | event name of | |
| | a specific | |
| | event | |
| Referrer | Sender URI | page://foobar.com/foobar |
| | Sender PageID | p1262304179432856320 |

In a PageLink, the field of URI of target Page is filled with “Definite URI” or “General URI.” When needActive=True in Table 1, the target Page is activated; that is, the Shown-active state is entered. In Table 1, except for the Referrer field, fields can be appointed by the PageLink sender. The Referrer field can be automatically filled by a core frame layer of the YunOS system.

In a practical service scenario, multiple Pages may need to interact in a series mode. For example, PageA needs to transmit data and events to PageB via the PageLink, PageA may also simultaneously need to transmit data and events to PageC via the PageLink, PageB needs to transmit data and events to PageD via the PageLink, and so on. In this case, every two Pages that need to transmit data and events via the PageLink can interact in a mode provided according to the above embodiments, so that all Pages needed in one service process are connected in series to transmit data and events based on the PageLink and accomplish the service process.

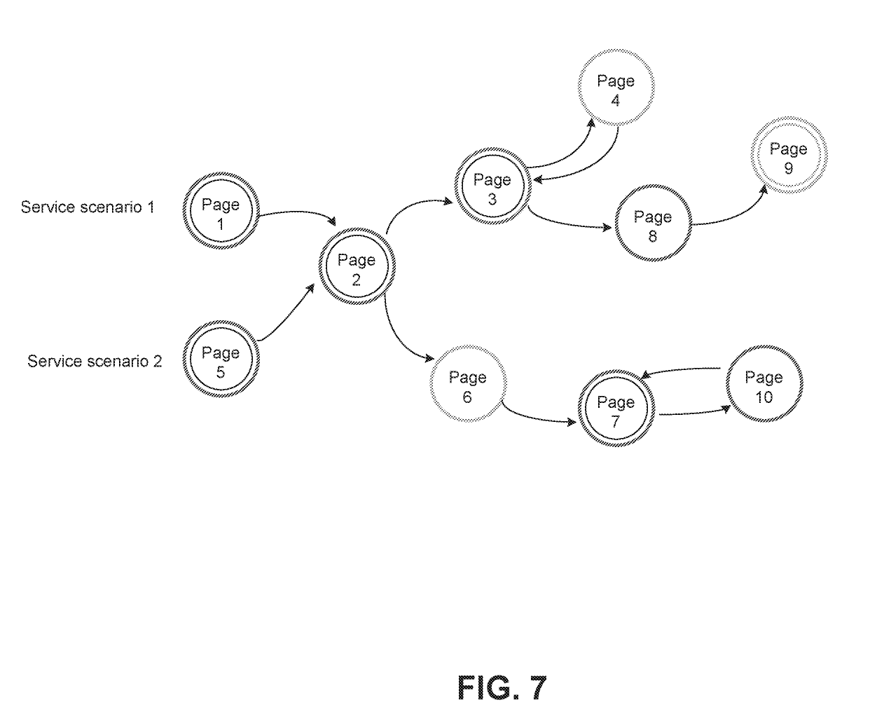

FIG. 7 is an example of an association of Pages in two service scenarios. In service scenario 1, the operation of a user on the UI of the service triggers Page1 to generate a Page2-oriented PageLink, which is sent to Page2 via the DPMS. Page2 receives the PageLink sent by Page1, processes the PageLink, and generates a Page3-oriented PageLink, which is sent to Page3 via the DPMS. Page3 receives the PageLink, processes the PageLink, generates a Page4-oriented PageLink that is sent to Page4 via the DPMS, and generates a Page9-oriented PageLink that is sent to Page9 via the DPMS. Page4 receives the PageLink, processes the PageLink, and returns the processing result to Page3.

In service scenario 2, the operation of a user on the UI of the service triggers Page5 to generate a Page2-oriented PageLink, and the PageLink is sent to Page2 via the DPMS. Page2 receives the PageLink sent by Page5, processes the PageLink, and generates a Page6-oriented PageLink, which is sent to Page6 via the DPMS. Page6 receives the PageLink, processes the PageLink, and generates a Page7-oriented PageLink, which is sent to Page7 for processing via the DPMS. Page7 receives the PageLink, processes the PageLink and generates a Page10-oriented PageLink, which is sent to Page10 for processing via the DPMS. Page10 receives the PageLink, processes the PageLink, and returns the processing result to Page7.

Taking the above travel service scenario as an example, if a service process of the scenario is accomplished, multiple Pages are needed and executed in a certain logical sequence, as follows:

1. PageA Sends a PageB-Oriented PageLink to the DPMS.

In this example, PageA is a travel strategy application, and PageB is a flight ticket and hotel query application. In the options of the PageLink, inGroup=false, needActive=True. In the data of the PageLink, the parameters to be transmitted include destination and round-trip time, and can also include other parameters such as the price ranges of the flight ticket and hotel. PageA can acquire specific values of the data, and the data is carried in the PageLink. In this example, after receiving the PageLink, PageB can inquire about corresponding round-trip flight tickets and hotels within the period of time specified by the transmitted destination and round-trip time, and PageB can return the inquiry results to PageA.

2. PageB Sends a PageC-Oriented PageLink to the DPMS.

In this example, PageC is a payment application. In the options of the PageLink, inGroup=true, needActive=true. In the data of the PageLink, the parameters to be transmitted include booked flight information, booked hotel information, and payment account information for the user. In this example, PageB can make payment using the payment account information according to the transmitted booking information for the flight ticket and the hotel after receiving the PageLink, and PageC can return the payment result to PageB via the DPMS.

3. PageA Sends a PageD-Oriented PageLink to the DPMS.

In this example, PageD is a weather query application. In the options of the PageLink, inGroup=false, needActive=false. In the data of the PageLink, the parameters to be transmitted include destination and round-trip time. In this example, PageD can inquire about the weather conditions of the destination within the corresponding time period according to the transmitted destination and round-trip time after receiving the PageLink, and PageD can return the query result to PageA via the DPMS.

It can be seen from the above discussion that, in YunOS for example, pages required by a service scenario can be serially connected in a quite natural manner, as shown in the above examples. For example, Pages for browsing a web page to plan an itinerary, then jumping to hotel and ticket services at a place of interest, then jumping to a payment service, and then jumping to a weather service page can be serially connected in a quite natural manner. In this process, the data of the front Page is transmitted to the next Page via the PageLink, so that the user does not need to repeatedly input data. One Page provides a certain local or remote service. Jumping between the Pages is not limited by application, and various services can be realized by combining a few Pages via a PageLink.

The above embodiments can be implemented with a cloud operating system. A cloud OS, which can also be referred to as a cloud operating system, cloud computing operating system, or cloud computing center operating system, is an operating system supported by cloud computing and cloud storage technologies, and is a management operating system for a cloud computing background data center. The cloud OS is a cloud-platform and comprehensive management system structured on a hardware source and stand-alone operating system that includes a server, memory, a network and the like, and basic software including middleware, a database, and the like, used for managing hardware and software resources.

Embodiments of the present invention also provide a service component management device, which can use the DPMS as presented above.

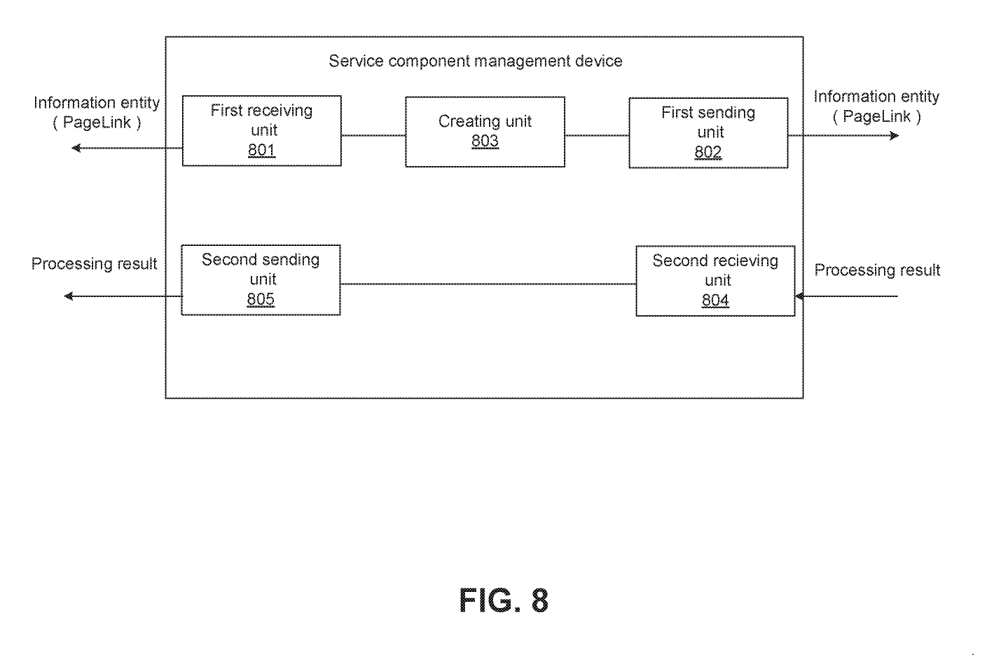

FIG. 8 is a block diagram of an example of a service component management device according to an embodiment of the present invention. The device can include a first receiving unit 801 and a first sending unit 802. The first receiving unit 801 is used for receiving a second service component-oriented information entity sent by a first service component. The first sending unit 802 is used for sending the information entity to the second service component.

The device can further include a creating unit 803, which is used for creating an instance of the second service component before the information entity is sent to the second service component. The creating unit 803 can be used for acquiring executable program code corresponding to the second service component, executing the executable program code, and allocating an execution environment to the executable program code.

The device can also include a second receiving unit 804, used for receiving a result of processing the information entity returned by the second service component after the information entity is sent to the second service component, and a second sending unit 805, used for sending the processing result returned by the second service component to the first service component.

The second service component is a local service component or a remote service component. In an embodiment, the first sending unit 802 is used for determining whether the second service component is a local service component or a remote service component. If the second service component is a remote service component, the first sending unit 802 is used sending the information entity to a server corresponding to the second service component.

The second receiving unit 804 is also used for receiving a result of processing the information entity sent by the server after the information entity is sent to the server corresponding to the second service component, and the second sending unit 805 is also used for sending the processing result sent by the server to the first service component.

Optionally, the information entity includes at least a URI of a target service component, and the URI of the target service component corresponds to one or more second service components. The URI of the target service component also carries parameters. The parameters are determined according to the event received by the first service component. The event includes an event generated when a control on a user interface corresponding to the first service component is triggered, a set system event, or a set non-system event. Optionally, the parameters are used for indicating set entries of the second service component. Optionally, the information entity further includes one or any combination of data and events.

When the information entity includes at least a URI of a target service component and an event, the URI of the target service component can include information for characterizing a broadcast event. In that case, the first sending unit 802 is used for determining at least one second service component registered to listen to the event according to the information included in the URI of the target service component in the information entity and used for characterizing the broadcast event, and is also used for sending the information entity to the second service component registered to listen to the event.

Optionally, the information entity also includes indication information, which is used for determining the ongoing processing operation by the second service component. The indication information includes first indication information used for indicating whether the first service component and the second service component are in the same service component group. The service component group includes at least two service components, and is set according to a service scenario.

The indication information can also include second indication information used for indicating whether the target service component needs to enter a specified state or for indicating an interactive mode between the target service component and a user interface. The specified state includes at least one of the following states: a hidden state, in which the service component runs in the background and is invisible to a user; a shown-inactive state, in which the service component is visible to a user but does not respond to a user input; and a shown-active state, in which the service component is visible to a user and responds to a user input. The interactive mode includes at least one of the following modes: a shown-active mode; and a shown-inactive mode.

Optionally, the information entity also includes a URI of the first service component and/or a component ID of the second service component, where the component ID is used for indicating an instance corresponding to the ID among the multiple instances when the second service component has multiple instances.

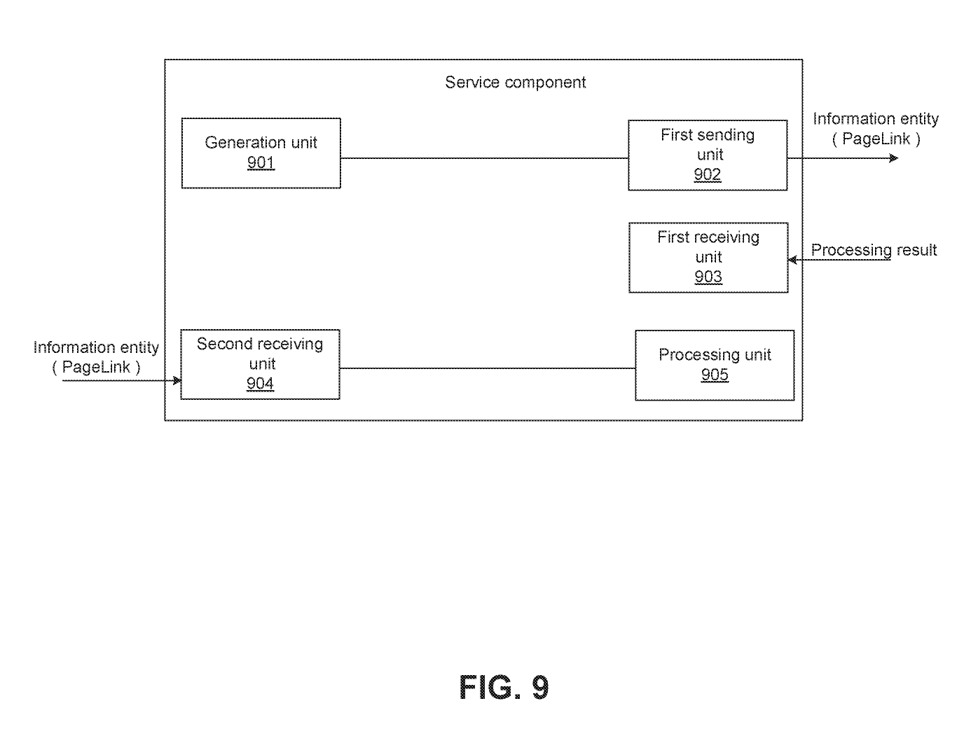

Embodiments according to the present invention further provide a service component. FIG. 9 is a block diagram of an example of a service component in an embodiment according to the present invention. As shown in FIG. 9, the service component can include a generation unit 901 and a sending unit 902. The generation unit 901 is used for generating a second service component-oriented information entity according to the received information including an event and/or data. The sending unit 902 is used for sending the information entity (e.g., to a second service component). The second service component is a local service component or a remote service component.

The event includes, for example, an event generated when a control on a UI corresponding to the first service component is triggered, a set system event, or a set non-system event.

The generation unit 901 can be used for determining a target service component configured with the event according to the received event, and for writing the URI of the target service component to a corresponding field of the information entity. The generation unit can also be used for writing the received event and/or data to a corresponding field of the information entity when generating the information entity according to the received information.

Further, the service component can include a first receiving unit 903 for receiving a result of processing the information entity returned by the second service component.

In an embodiment, the service component further includes a second receiving unit 904 and a processing unit 905. The second receiving unit 904 can be used for receiving a first service component-oriented information entity sent by a third service component, and the processing unit 905 can be used for processing the information entity received by the second receiving unit. More specifically, if the information entity received by the receiving unit includes data and an event, the processing unit 905 can be used for executing an operation corresponding to the event included in the information entity according to the data included in the information entity.

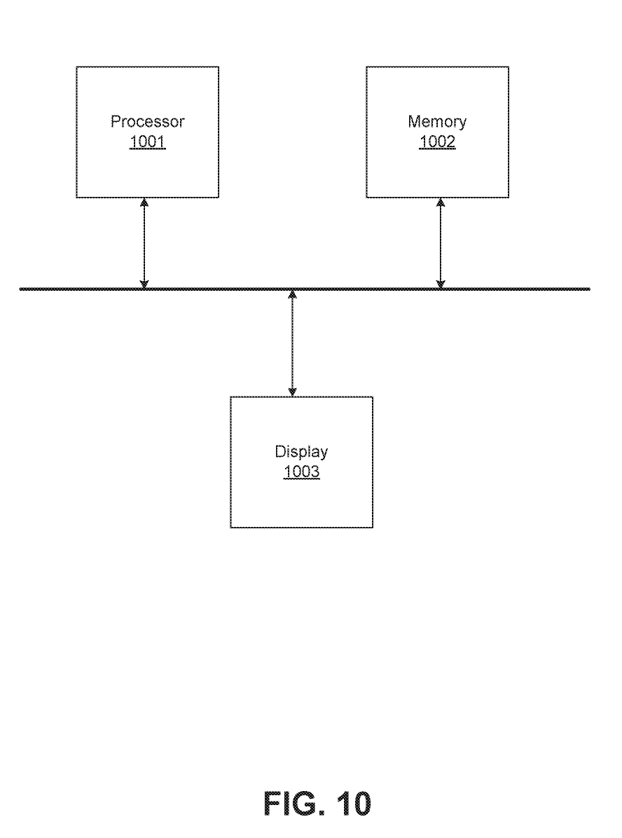

Embodiments according to the present application also provide a terminal device. FIG. 10 is a block diagram of an example of a terminal device in an embodiment according to the present invention. The terminal device includes a processor 1001, a memory 1002, and a display 1003.

The processor 1001 may be a general processor (e.g., a microprocessor or any conventional processor, etc.), a digital signal processor, a dedicated integrated circuit, a field programmable gate array or other programmable logic devices, a discrete gate or transistor logic device, or a discrete hardware component. The memory 1002 specifically may include an internal memory and/or an external memory, e.g., a random access memory, a flash memory, a read-only memory, a programmable read-only memory or an electrically erasable programmable memory, a register and other mature storage medium in the art. The display 1003 may include a touch screen control circuit.

The processor 1001 is in communication with other modules based on, for example, a bus architecture. The bus architecture may include any number of interconnected buses and bridges, and specifically connects various circuits of one or more processors represented by the processor 1001 and memories represented by the memory 1002. The bus architecture may further connect various other circuits such as peripheral equipment, a voltage stabilizer, a power management circuit, and the like. A bus architecture is known in the art and so is not further described in the present application. The processor 1001 takes charge of managing the bus architecture and common processing, and the memory 1002 can store data used when the processor 1001 executes operations.

The processes disclosed herein can be applied to the processor 1001 or realized by the processor 1001. In the implementation process, the process steps can be accomplished via an integrated logic circuit of hardware in the processor 1001 or instructions in the form of software. The methods, the steps, and the logic block diagrams disclosed in the present application can be realized or executed in this manner. The steps of the methods disclosed in the embodiments of the present application can be directly executed by a hardware processor or a combination of hardware and software modules in the processor. The software modules can be located in a storage medium such as a random memory, a flash memory, a read-only memory, a programmable read-only memory or an electrically erasable programmable memory, a register or the like.

Specifically, the processor 1001 is coupled to the memory 1002 and is used for reading computer program instructions stored in the memory 1002. In response, the processor 1001 executes operations including receiving a second service component-oriented information entity sent by a first service component, and sending the information entity to the second service component.

Before sending the information entity to the second service component, the processor 1001 is further used for creating an instance of the second service component.

The process in which the processor 1001 creates the instance of the second service component includes acquiring executable program code corresponding to the second service component, executing the executable program code, and allocating an execution environment to the executable program code.

The processor 1001 can be further used for receiving a result of processing the information entity returned by the second service component after sending the information entity to the second service component, and sending the processing result returned by the second service component to the first service component.

Optionally, the information entity includes at least a URI of a target service component, and the URI of the target service component corresponds to one or more second service components. The URI of the target service component also carries parameters. The parameters are determined according to the event received by the first service component. The event includes an event generated when a control on a UI corresponding to the first service component is triggered, a set system event, or a set non-system event.

The parameters can be used for indicating set entries of the second service component.

The information entity further includes, for example, one or any combination of the following contents: data and events.

If the information entity includes data and an event, then the processor 1001 can execute an operation corresponding to the event included in the information entity according to the data included in the information entity.

When the information entity at least includes a URI of a target service component and an event, the URI of the target service component includes information for characterizing a broadcast event. Correspondingly, the processor 1001 can be used for determining at least one second service component registered to listen to the event according to the information included in the URI of the target service component in the information entity and used for characterizing the broadcast event, and sending the information entity to the second service component registered to listen to the event.

Optionally, the information entity further includes indication information, which is used for determining the ongoing processing operation by the second service component. The indication information includes first indication information used for indicating whether the first service component and the second service component are in the same service component group. The service component group includes at least two service components, and is set according to a service scenario.

The indication information can also include second indication information used for indicating whether the target service component needs to enter a specified state or for indicating an interactive mode between the target service component and a user interface. The specified state includes at least one of the following states: a hidden state, in which the service component runs in the background and is invisible to a user; a shown-inactive state, in which the service component is visible to a user but does not respond to a user input; and a shown-active state, in which the service component is visible to a user and responds to a user input.

The interactive mode includes at least one of the following modes: a shown-active mode and a shown-inactive mode.

Optionally, the information entity further includes a URI of the first service component and/or a component identifier (ID) of the second service component, where the component ID is used for indicating an instance corresponding to the ID among the multiple instances when the second service component has multiple instances.

The processor 1001 can determine whether the second service component is a local service component or a remote service component. If the second service component is a remote service component, the processor 1001 can send the information entity to a server corresponding to the second service component.

Further, after sending the information entity to the server corresponding to the second service component, the processor 1001 can receive a processing result sent by the server on the information entity, and can send the processing result sent by the server to the first service component.

Although embodiments of the present invention have been shown and described above, it could be understood that the above embodiments are examples and cannot be regarded as limiting the present invention, and changes, modifications, substitutions and variations could be made by those of ordinary skill in the art within the scope of the present invention.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system and executed by a processor. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

Although the subject matter has been described in language specific to structural features and/or methodological acts, it is to be understood that the subject matter defined in the disclosure is not necessarily limited to the specific features or acts described above. Rather, the specific features and acts described above are disclosed as example forms of implementing the disclosure.

Embodiments according to the invention are thus described. While the present disclosure has been described in particular embodiments, it should be appreciated that the invention should not be construed as limited by such embodiments, but rather construed according to the following claims.

What is claimed is:

1. A computer-implemented service component management method, comprising:
receiving a second service component-oriented information entity for a second service component for providing a second service, the information entity sent by a first service component for providing a first service different from the second service; and
sending the information entity to the second service component.

2. The method of claim 1, further comprising:
before said sending, creating an instance of the second service component.

3. The method of claim 2, wherein said creating comprises:
acquiring executable program code corresponding to the second service component;
executing the executable program code; and
allocating an execution environment to the executable program code.

4. The method of claim 1, further comprising:
after sending the information entity to the second service component:
receiving a result of processing the information entity returned by the second service component; and
sending the result to the first service component.

5. The method of claim 1, wherein the information entity at least comprises a uniform resource identifier (URI) of a target service component, and the URI of the target service component corresponds to one or more second service components.

6. The method of claim 5, wherein the URI of the target service component also comprises parameters that are determined according to the event received by the first service component, wherein the parameters are used for indicating set entries of the second service component and wherein the event is selected from the group consisting of: an event generated when a control on a user interface (UI) corresponding to the first service component is triggered; a set system event; and a set non-system event.

7. The method of claim 5, wherein the information entity further comprises one or any combination of data and events;
wherein the method further comprises processing the information entity using the second service component, wherein if the information entity includes data and an event then said processing the information entity comprises executing an operation corresponding to the event included in the information entity according to the data included in the information entity;
wherein when the information entity comprises at least a URI of a target service component and an event, the URI of the target service component comprises information for characterizing a broadcast event, wherein said sending the information entity to the second service component comprises:
determining at least one second service component registered to listen to the event according to the information included in the URI of the target service component in the information entity and used for characterizing the broadcast event; and
sending the information entity to the second service component registered to listen to the event.

8. The method of claim 5, wherein the information entity further comprises indication information that is used for determining the ongoing processing operation by the second service component, wherein the indication information comprises first indication information that is used for indicating whether the first service component and the second service component are in the same service component group, wherein the service component group comprises at least two service components and is set according to a service scenario, wherein the indication information further comprises second indication information that is used for indicating whether the target service component needs to enter a specified state or for indicating an interactive mode between the target service component and a user interface, wherein the interactive mode comprises at least one of the following modes:
a shown-active mode; and
a shown-inactive mode; and
wherein the specified state comprises at least one of the following states:
a hidden state, in which the service component runs in the background and is invisible to a user;
a shown-inactive state, in which the service component is visible to a user but does not respond to a user input; and
a shown-active state, in which the service component is visible to a user and responds to a user input.

9. The method of claim 5, wherein the information entity further comprises at least one of:
a URI of the first service component; and
a component identifier (ID) of the second service component, wherein the component ID is used for indicating an instance corresponding to the ID among the multiple instances when the second service component has multiple instances.

10. The method of claim 1, wherein the second service component is a local service component or a remote service component, wherein said sending the information entity to the second service component comprises:
determining whether the second service component is a local service component or is a remote service component;
if the second service component is a remote service component, then sending the information entity to a server corresponding to the second service component; and
after sending the information entity to the server corresponding to the second service component:
receiving a result of processing the information entity sent by the server; and
sending the result sent by the server to the first service component.

11. A computer-implemented service component interaction method, comprising:
generating, with a first service component for performing a first service, a second service component-oriented information entity according to received information comprising an event and/or data; and
sending the information entity from the first service component to a second service component for performing a second service different from the first service.

12. The method of claim 11, wherein the event is selected from the group consisting of: an event generated when a control on a UI corresponding to the first service component is triggered; a set system event; and a set non-system event.

13. The method of claim 11, wherein said generating the second service component-oriented information entity comprises:
determining, with the first service component, a target service component configured with the event according to the received event; and
writing, with the first service component: the URI of the target service component to a corresponding field of the information entity, and the received event and/or data to a corresponding field of the information entity.

14. The method of claim 11, further comprising receiving a result of processing the information entity returned by the second service component.

15. The method of any of claim 11, further comprising:
receiving a first service component-oriented information entity sent by a third service component; and
processing the received information entity, wherein said processing the received information entity comprises, executing an operation corresponding to the event included in the information entity according to the data included in the information entity if the received information entity comprises data and an event.

16. A device, comprising:
a processor; and
memory coupled to the processor, wherein the memory stores instructions that, when executed, cause the processor to execute operations comprising:
receiving a second service component-oriented information entity for a second service component for providing a second service, the information entity sent by a first service component for providing a first service different from the second service; and
sending the information entity to the second service component.

17. The device of claim 16, wherein the operations further comprise:
creating an instance of the second service component before the information entity is sent to the second service component;
acquiring an executable program code corresponding to the second service component;
executing the executable program code; and
allocating an execution environment to the executable program code.

18. The device of claim 16, wherein the operations further comprise:
receiving a result of processing the information entity returned by the second service component after the information entity is sent to the second service component; and
sending the result returned by the second service component to the first service component.

19. The device of claim 18, wherein the second service component is a local service component or a remote service component, wherein the operations further comprise:
determining whether the second service component is a local service component or a remote service component;
sending the information entity to a server corresponding to the second service component if the second service component is a remote service component;
receiving a result of processing the information entity sent by the server after the information entity is sent to the server corresponding to the second service component; and
sending the result sent by the server to the first service component.

20. The device of claim 16, wherein the information entity comprises at least a uniform resource identifier (URI) of a target service component, and the URI of the target service component corresponds to one or more second service components.

21. The device of claim 20, wherein the URI of the target service component also comprises parameters that are determined according to the event received by the first service component and are used for indicating set entries of the second service component, wherein the event is selected from the group consisting of: an event generated when a control on a user interface (UI) corresponding to the first service component is triggered, a set system event, and a set non-system event.

22. The device of claim 20, wherein the information entity further comprises one or any combination of data and events, wherein the second service component processes the information entity, and wherein when the information entity comprises at least a URI of a target service component and an event, the URI of the target service component comprises information for characterizing a broadcast event; wherein the operations further comprise:
determining at least one second service component registered to listen to the event according to the information included in the URI of the target service component in the information entity and used for characterizing the broadcast event; and
sending the information entity to the second service component registered to listen to the event.

23. The device of claim 20, wherein the information entity further comprises indication information useful for determining the ongoing processing operation by the second service component, wherein the indication information comprises first indication information useful for indicating whether the first service component and the second service component are in the same service component group, wherein the service component group comprises at least two service components and is set according to a service scenario, wherein the indication information further comprises second indication information useful for indicating whether the target service component needs to enter a specified state or for indicating an interactive mode between the target service component and a user interface;
wherein the specified state comprises at least one of the following states:
a hidden state, in which the service component runs in the background and is invisible to a user;
a shown-inactive state, in which the service component is visible to a user but does not respond to a user input; and
a shown-active state, in which the service component is visible to a user and responds to a user input; and
wherein the interactive mode comprises at least one of the following modes:
a shown-active mode; and
a shown-inactive mode.

24. The device of claim 20, wherein the information entity further comprises at least one of:
a URI of the first service component; and
a component identifier (ID) of the second service component, wherein when the second service component has multiple instances then the component ID is used for indicating an instance corresponding to the component ID among the multiple instances.

25. A first service component for providing a service, comprising:
a generation unit, operable for generating a second service component-oriented information entity according to received information including an event and/or data; and
a sending unit, operable for sending the information entity to a second service component for providing a service.

26. The first service component of claim 25, wherein the generation unit is further operable for:
determining a target service component configured with the event according to the received event;
writing the URI of the target service component to a corresponding field of the information entity; and
writing the received event and/or data to a corresponding field of the information entity when generating the information entity according to the received information.

27. The first service component of claim 25, further comprising a first receiving unit operable for receiving a result of the information entity returned by the second service component.

28. The first service component of claim 25, further comprising:
a second receiving unit operable for receiving a first service component-oriented information entity sent by a third service component; and
a processing unit operable for processing the information entity received by the second receiving unit and operable for executing an operation corresponding to the event included in the information entity according to the data included in the information entity if the information entity received by the receiving unit comprises data and an event.

29. A terminal device, comprising:
a memory operable for storing computer program instructions; and
a processor, coupled to the memory, and operable for reading the computer program instructions stored in the memory and executing the following operations:
receiving a second service component-oriented information entity for a second service component for providing a second service, the information entity sent by a first service component for providing a first service different from the second service; and
sending the information entity to the second service component.

30. A computer-readable medium having stored thereon, computer-executable instructions that, responsive to execution by a device, cause the device to perform operations comprising:
receiving a second service component-oriented information entity for a second service component for providing a second service, the information entity sent by a first service component for providing a first service different from the second service; and
sending the information entity to the second service component.

31. The computer-readable medium of claim 30, wherein the operations further comprise:
before said sending, creating an instance of the second service component;
acquiring executable program code corresponding to the second service component;
executing the executable program code; and
allocating an execution environment to the executable program code.

32. The computer-readable medium of claim 30, wherein the operations further comprise:
after sending the information entity to the second service component:
receiving a result of processing the information entity returned by the second service component; and
sending the result to the first service component.

33. The computer-readable medium of claim 30, wherein the information entity at least comprises a uniform resource identifier (URI) of a target service component, and the URI of the target service component corresponds to one or more second service components.

34. The computer-readable medium of claim 30, wherein the second service component is a local service component or a remote service component, wherein said sending the information entity to the second service component comprises:
determining whether the second service component is a local service component or is a remote service component;
if the second service component is a remote service component, then sending the information entity to a server corresponding to the second service component; and
after sending the information entity to the server corresponding to the second service component:
receiving a result of processing the information entity sent by the server; and
sending the result sent by the server to the first service component.
